(19) United States
(12) Patent Application Publication
(10) Pub. No.: US 2019/0315633 A1
(43) Pub. Date: Oct. 17, 2019

(54) OZONE SENSOR

(71) Applicant: DELTA FAUCET COMPANY, Indianapolis, IN (US)

(72) Inventors: KLAUS BRONDUM, ANN ARBOR, MI (US); GARRY ROBIN MARTY, FISHERS, IN (US)

(21) Appl. No.: 15/952,930

(22) Filed: Apr. 13, 2018

(51) Int. Cl. C02F 1/00; C02F 1/78; G01N 27/416; G01N 27/38; G01N 27/28

(52) U.S. Cl. CPC C02F 1/008; C02F 1/78; G01N 27/4168; G01N 27/38; C02F 2303/04; C02F 2201/782; C02F 2209/001; C02F 2209/23; G01N 27/283

(57) ABSTRACT

An ozone sensor includes a hollow housing having an inlet and an outlet. The hollow housing defines an internal cavity that is adapted to receive water from the inlet and discharge water through the outlet. The internal cavity can be defined by a bottom wall, a top wall and sidewall. An electrode includes a working electrode, a counter electrode, and a reference electrode. The electrode assembly positioned in the cavity such that the reference electrode is below the inlet and outlet when to ozone is incorporated in a water line such that the hollow housing retains water.

### TECHNICAL FIELD

In at least one aspect, the present invention is related to water treatment systems in which water is treated with ozone.

### BACKGROUND

The ozone treatment of water is well established for the disinfection and purification of water. The oxidation properties of ozone allow the removal of inorganic and organic contaminants as well as the removal of microbial pathogens. When water is treated with ozone, it is desirable to implement techniques in which the amount of ozone is quantified to ensure that a sufficient concentration is being provided.

Although methods for quantifying ozone potentiostatically (measure current while potential is constant) are known, these techniques include numerous drawbacks. In such methods, an electric potential is applied between an electrode and a reference with the resulting current being a measure of ozone. In the process, ozone is reduced to water. Moreover, at least some commercially available ozone sensors have slow response times. Electrodes used for ozone sensing include gold, platinum, palladium and the like. Gold is preferred over platinum metals that tend to develop stable oxides because of calibration issues. Moreover, electrodes are susceptible to lime scale from the electrolysis which in effect changes electrode area and response calling for recalibration. A common way of restoring electrode function is by dissolving lime scale by reversing current direction (polarity). However, the preferred electrode material, gold, tends to dissolve when operated in reversing modes. Biofilms also tend over time to cover electrodes, altering the response. In these prior art techniques, other oxidants can interfere with measurements. Such oxidants include chlorine/hypochlorite or oxygen.

Accordingly, there is a need for improved methods of measuring ozone concentration in water treatment systems.

### SUMMARY

The present invention solves one or more problems of the prior art by providing in at least one embodiment an ozone sensor. The ozone sensor includes a hollow housing having an inlet and an outlet. The hollow housing defines an internal cavity that is adapted to receive water from the inlet and discharge water through the outlet. The internal cavity can be defined by a bottom wall, a top wall and sidewall. An electrode includes a working electrode, a counter electrode, and a reference electrode. The electrode assembly is positioned in the cavity such that the reference electrode is below the inlet and outlet when ozone is incorporated in a water line such that the hollow housing retains water.

In another embodiment, a system for treating water with ozone is provided. The system includes an ozone generator disposed in a water supply line and an ozone sensor disposed in a water supply line upstream of the ozone sensor. The ozone sensor includes a hollow housing having an inlet and an outlet. The hollow housing defines a cavity that is adapted to receive water from the inlet and discharge water through the outlet. The cavity is defined by a bottom wall, a top wall and sidewall. An electrode includes a working electrode, a counter electrode, and a reference electrode. The electrode assembly is positioned in the cavity such that the reference electrode is below the inlet and outlet when ozone is incorporated in a water line such that the hollow housing retains water. A controller is in electrical communication with the ozone generator and the ozone sensor. The controller adjusts the amount of ozone generated by the ozone generator using feedback from the ozone concentration determined by the ozone sensor.

### BRIEF DESCRIPTION OF THE DRAWINGS

FIG. 1 provides a schematic illustration of an ozone generating system that allows feedback control of an ozone generator.

FIG. 2 is a schematic illustration of an ozone sensor.

FIG. 3 is an exploded view of the ozone sensor of FIG. 2.

FIG. 4 is a top view of a screw cap used to hold the top flange on top of the ozone sensor housing.

FIG. 5A is a side view of the electrode assembly showing the face of the substrate with the working, counter, and reference patterned electrodes.

FIG. 5B is a side view of the electrode assembly showing the face of the substrate with the working and counter patterned electrodes with a separate reference electrode assembly.

FIG. 6A is a side view of the electrode assembly attached to a top flange showing the face of the substrate with the working and counter patterned electrodes with a separate reference electrode assembly.

FIG. 6B is a side view of the electrode assembly attached to a top flange that is perpendicular to the view of FIG. 6A.

FIG. 7A is a side view of the electrode assembly and a wiper attached to a top flange.

FIG. 7B is a side view of the electrode assembly and a wiper attached to a top flange that is perpendicular to the view of FIG. 7A.

FIG. 8A is a front view of the electrode substrate and the flexible flap.

FIG. 8B is a side view of the electrode substrate and the flexible flap.

FIG. 9A is an electrical schematic of the three electrode configuration.

FIG. 9B is an electrical schematic of the two electrode configuration.

FIG. 10. Chip ozone sensor current during experiment.

FIG. 11. Data excerpt. Inserts of ozone concentration measured colometrically.

FIG. 12. Second time around at 50 Hz sampling rate 0.1 second average.

FIG. 13. Time response generator on.

FIG. 14. Time response generator off.

FIG. 15. Time response “Generator off water flow started”.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In an embodiment, a water treatment system that includes an electrochemical ozone sensor is provided. Water treatment system 10 includes ozone generator assembly 12 attached to water line 14. Water flows along direction f₁ through ozone generator assembly 12 where ozone is introduced into the flowing water. In a refinement, ozone generator assembly 12 includes ozone generating element 16. Ozone sensor assembly 18 is attached to water line 14 at a position downstream of ozone generator assembly 12. Ozone sensor assembly 18 can determine if ozone is present in water flow past the sensor elements 20. In a refinement, ozone sensor assembly 18 can quantify the concentration of ozone in the water flowing past the sensor elements 20. Water treatment system 10 also includes control electronics 22 that include controller 24 for controlling ozone sensor assembly 18 and controller 26 for receiving sensor signals from sensor elements 20. Processor 28 provides feedback control from the signals received from sensor elements 20 such that the amount of ozone produced by ozone generator assembly 12 can be adjusted to such that the ozone concentration at sensor elements 20 is within a predefined range.

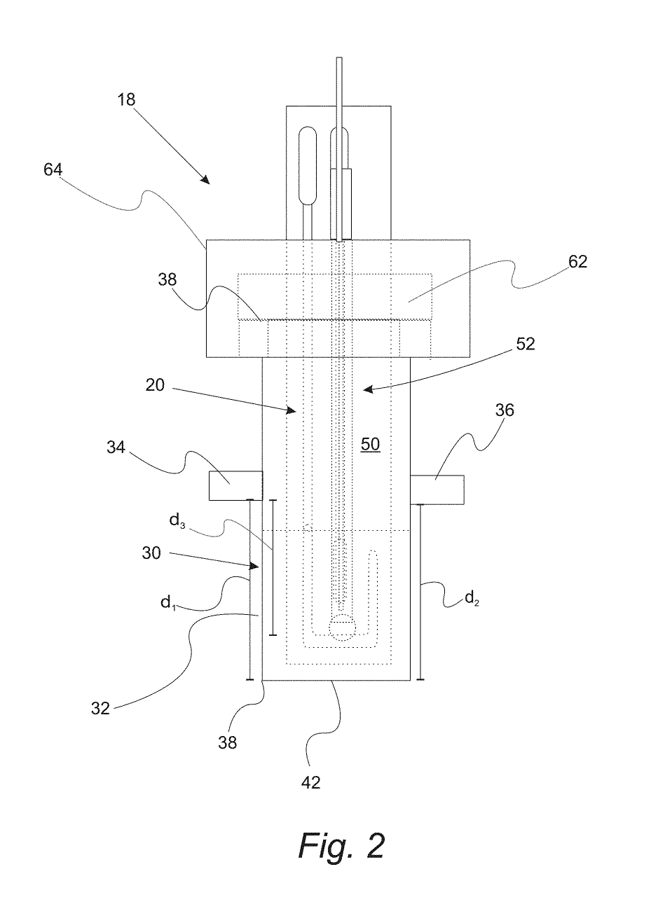

With reference to FIGS. 2, 3, and 4, schematic illustrations of an ozone sensor assembly are provided. Ozone sensor assembly 18 includes sensing elements 20 which are enclosed in hollow housing 30. Housing 30 includes a hollow columnar side wall 32 having inlet 34 and outlet 36. Hollow columnar side wall 32 has a first edge 38 and a second edge 40. Inlet 34 is positioned at a first distance d₁ from the first edge 38 and outlet 36 is positioned at a second distance dz from the first edge. These distances are the smallest distances between these structures. Housing 30 also includes a bottom wall 42 attached to first edge 38. Top flange 46 is removably attached to the second edge 40. Hollow columnar side wall 32, the bottom wall 42, and the top flange 46 define a chamber 50 that receives water through inlet 34 and discharges water through the outlet 36. The terms top and bottom refer to the orientation when ozone sensor assembly 18 is installed in a water line. Electrode assembly 52 includes sensor elements 20. Sensor elements 20 include a working electrode 56, a counter electrode 58, and a reference electrode 60. Electrode assembly 52 is attached to the top flange 62 such that the reference electrode is positioned at a third distance d₃ from the first edge that is less than the first distance d₁ and the second distance dz. The distance d₃ ensures that the reference electrode 60 is immersed in retained water after installation in a water line. In a refinement, inlet 34 and outlet 36 are substantially across each other on the hollow columnar side wall. Top flange 62 is attached to second edge 40 via screw cap 64. In another refinement, orientation of the electrode assembly 52 with respect to the inlet is adjustable such that water velocity over a surface of the electrode assembly can be varied. The ozone sensor orientation of the planar portion of the top flange is adjustable with respect to flow.

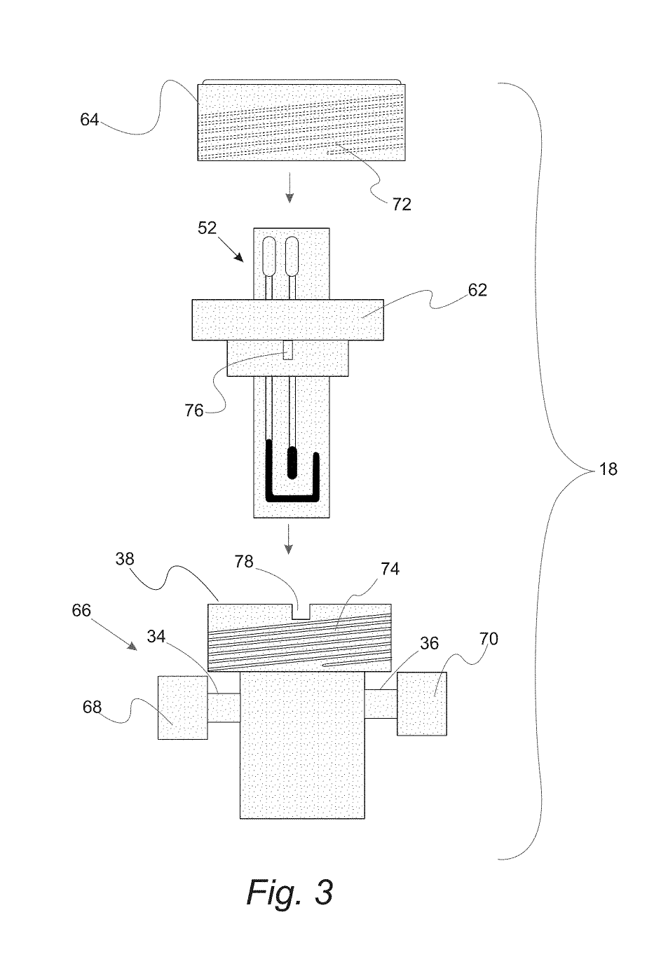

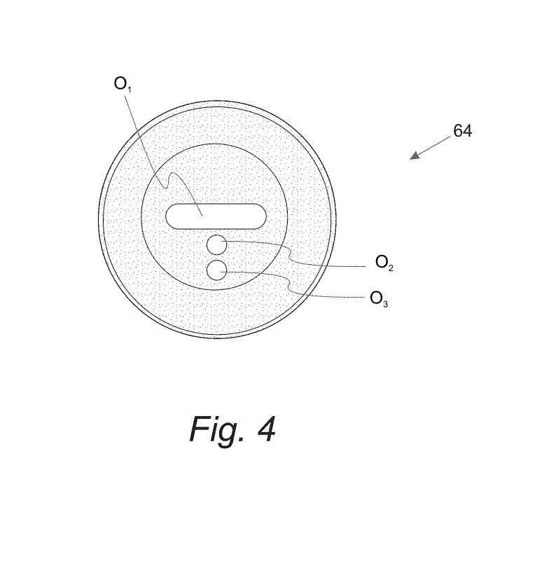

FIG. 3 provides an exploded view of ozone sensor assembly 18 illustrating the manner in which the components are assembled. The combination of electrode assembly 52 and top flange 62 is attached to housing receptacle component 66 which includes inlet 34 and outlet 36 which can include couplers 68 and 70 to facilitate installation in a water line. Screw cap 54 includes internal treads 72 which mate to external thread 74 of housing receptacle component 66. In a refinement, top flange 62 includes at least one protrusion 76 that is positioned into notch 78. First edge 38 defines one or more notches 78. Therefore, the top flange is rotatable with respect to the hollow columnar side wall to change orientation of the planar portion. Therefore, electrode assembly 52 can be positioned in multiple orientations with respect to the direction of water flow into ozone sensor assembly 18. FIG. 4 is a top view of screw cap 54 showing openings O1, O2, and O3 for positioning the electrode assembly, wiper and the reference electrode, respectively.

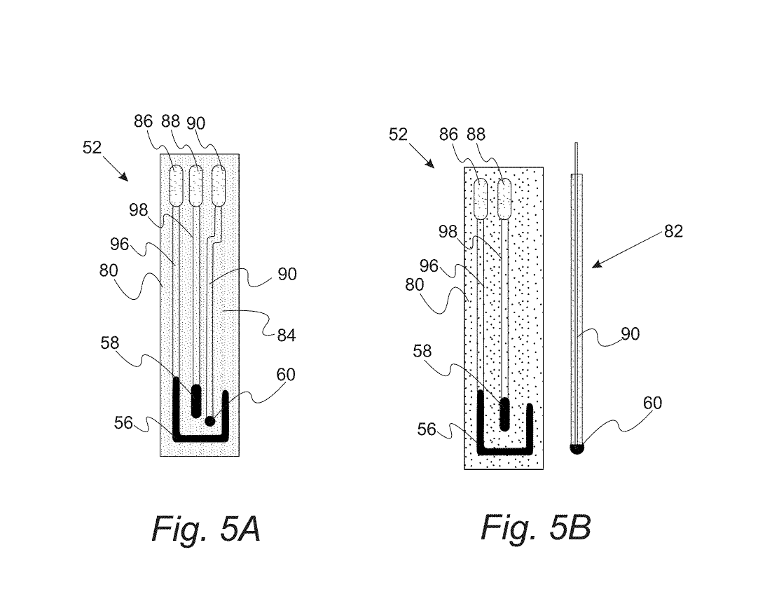

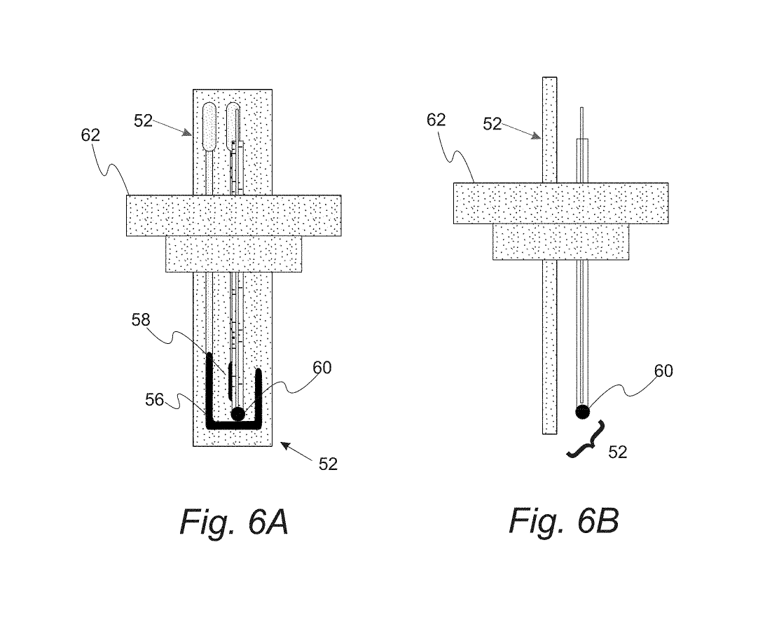

With reference to FIGS. 5A, 5B, 6A and 6B, schematic illustrations of the electrode assembly are provided. FIG. 5A shows an electrode assembly in which working electrode 56, counter electrode 58, and reference electrode 60 are patterned coatings on substrate 80. FIG. 5B shows an electrode assembly in which working electrode 56 and counter electrode 58, and a reference electrode 60 are parts of a separate assembly. In this latter variation, reference electrode 60 is part of a separate reference electrode assembly 82. Typically, substrate 80 is a plate made from a non-electrically conducting material such as ceramic or glass. Moreover, substrate 80 includes a planar portion 84 onto which at least a section of the working electrode and the counter electrode are disposed. In FIG. 5A, working electrode 56, counter electrode 58, and reference electrode 60 are attached to electrical contacts 86, 88, and 90 via leads 96, 98, and 100 which are also coated onto substrate 80. Leads 96, 98, and 100 are typically formed from an electrically conductive metal. In FIG. 5B, working electrode 56 and counter electrode 58 are attached to electrical contacts 86 and 88 via leads 96 and 98 which are also coated onto substrate 80. In this variation, reference electrode assembly 80 includes lead 100 enclosed with an insulating support structure (e.g., glass, ceramic, etc.). Advantageously, has a small footprint (e.g., about 0.8″×3″). FIGS. 6A and 6B provides schematic illustrations in which the electrode assembly of FIG. 6B is attached to top flange 62. FIG. 6A is a front side view showing the face of substrate 80 on which the working electrode and counter electrode are disposed. FIG. 5B is another side view perpendicular to the side view of FIG. 6B

In a variation, working electrode 56 and counter electrode 58, each independently include a precious metal. Typically, the working electrode 56 and counter electrode 58 are/include gold, palladium or platinum. The reference electrode 60 is typically a silver chloride electrode (Ag/AgCl). In a refinement, working electrode 56 is a gold electrode, counter electrode 58 is a platinum electrode, and reference electrode 60 is a silver chloride electrode.

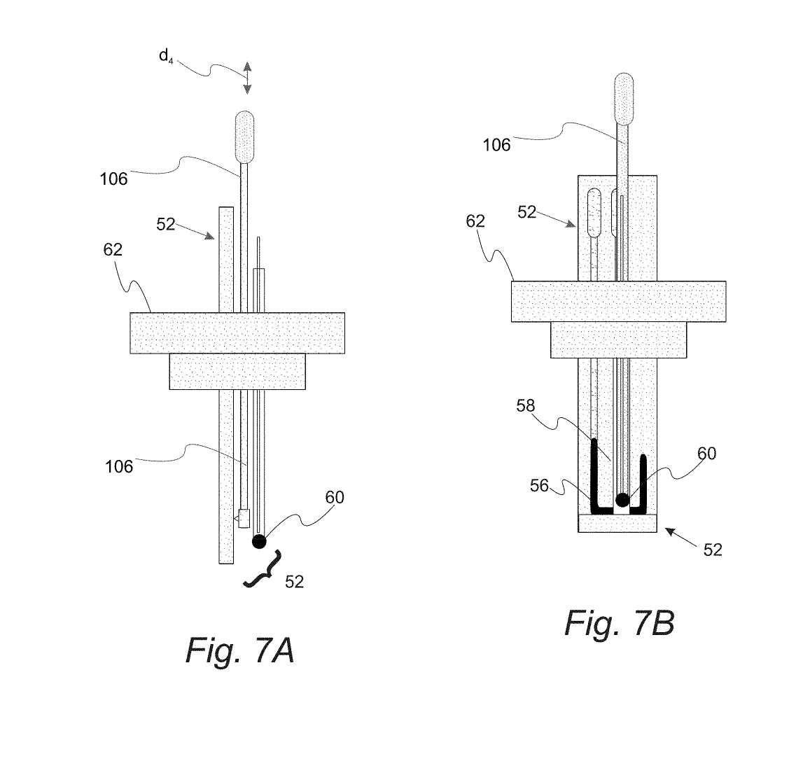

With reference to FIGS. 7A and 7B, schematic illustrations of a variation in which ozone sensor assembly 18 includes a wiper for cleaning the patterned electrode coatings are provided. FIG. 7A is a side view of electrode assembly 52 and wiper 106 attached to flange 62 perpendicular to substrate 80. FIG. 7B is a side view showing the face of substrate 80 with the patterned electrodes. Wiper 106 can be used to periodically clean electrode surfaces for debris, lime scale and biofilm build-up. A user moves wiper 106 along direction d₄ to clean the surfaces of the electrodes.

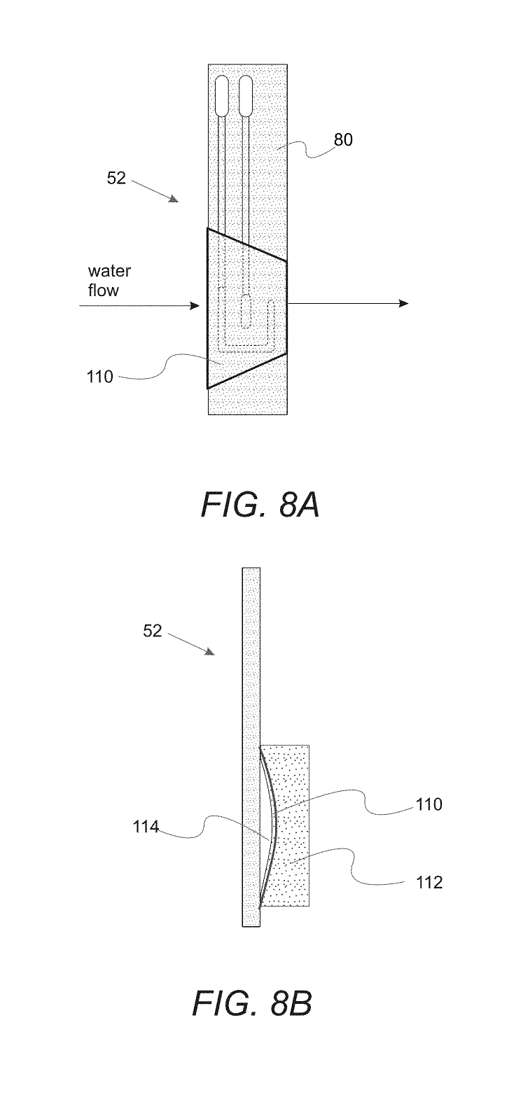

With reference to FIGS. 8A and 8B, a schematic illustration of flexible electrode flap design ensuring a minimum fluid velocity given a minimum flow enabling stable gain for residual oxidant measure irrespective of non-zero flow is provided. Flexible electrode flap 110 reduces the volume through which water can flow thereby increasing the water flow velocity. In a refinement, the water velocity is 0.1 m/s or greater. Typically, the water velocity will be less than 5 m/s. Flap 110 can include barrier 112 that prevents water from flowing on the outside of the flap such that the water flows through volume 114 where it contacts the electrodes. Potentiostatic and potentiometric measurements are sensitive to flow velocity. The potentiostatic measurement varies gain with flow while the time constant for accurate ORP increases in no flow situations. Both types of measurements benefit from high constant fluid velocity across the work electrode. For more accurate potentiostatic measure a flow dependent gain can be introduced.

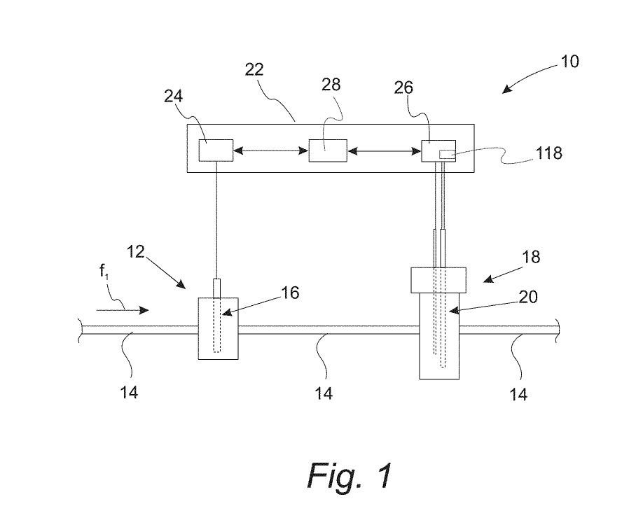

In a variation as depicted in FIGS. 1, 5A, 5B, 6A and 6B, water treatment system 10 includes a switching assembly 118 that selects between a three-electrode arrangement using the working electrode, counter electrode, and the reference electrode in a measurement and a two-electrode arrangement using the working electrode and the reference electrode. In a refinement, switching assembly 118 is in electrical communication with processor 28. The three-electrode arrangement allows potentiostatic measurements of residual oxidant using levels of potential to gage oxidant potency. In a variation, the potential between the working electrode and the reference electrode is from 0 to 1 V where increasing potential produces an oxidant, [Ox], concentration of increasing potency. In a refinement, the potential between the working electrode and the reference electrode is selected from a value of 0V, 0.35, or 0.70V where each level produces an oxidant, [Ox], concentration of increasing potency. In a refinement, the three electrode arrangement is selected when ozone concentrations is greater than a predefined ozone concentration and wherein the two electrode arrangement is selected when the ozone concentration is below the predefined ozone concentration.

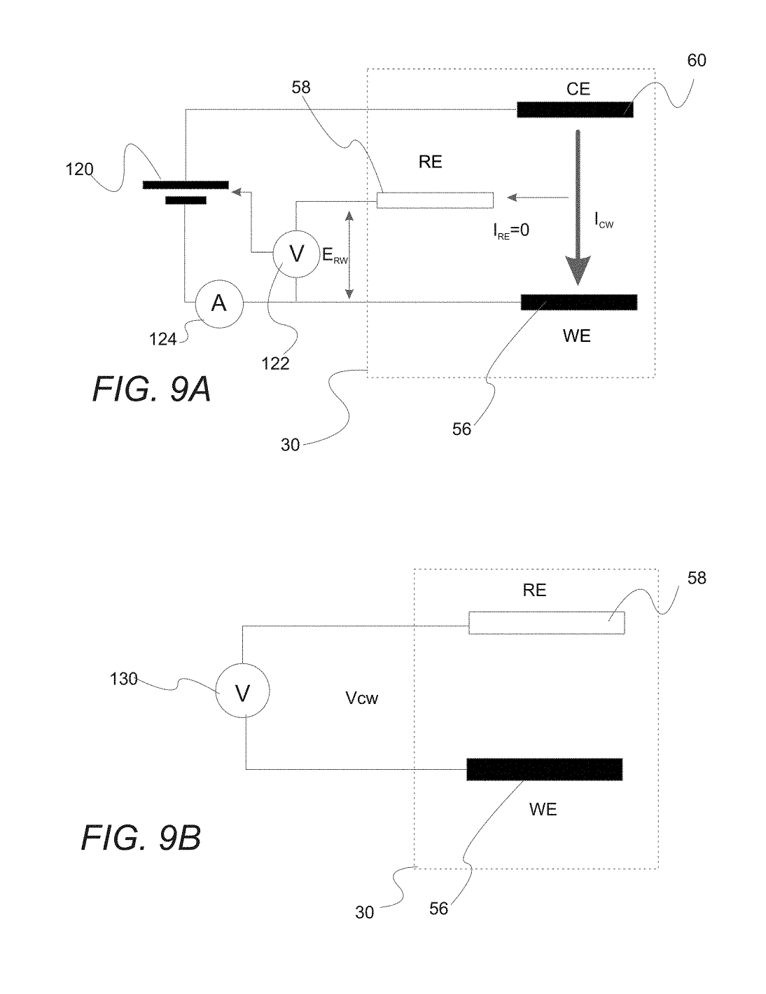

With reference to FIGS. 9A and 9B, schematics showing the three electrode and two electrode modes of operation are provided. FIG. 9A illustrates three electrode operation. Three electrode operation allows operation in potentiostatic mode which provides concentration information on oxidants present in the media (e.g., water). Voltage source 120 which can be a variable voltage source is used to provide a potential difference between working electrode 56 and counter electrode 60. In this variation, it is useful to use the platinum electrode as the counter electrode. Selectivity is provided by the potential applied between working electrode 56 and reference electrode 58 (e.g., Ag/AgCI with a potential relative to hydrogen of 0.23 V). The potential between working electrode 56 and reference electrode 58 can be provided by voltage source 120 or a separate variable voltage supply. The potential applied between working electrode 56 and reference electrode 58 is measured by voltage meter 122. Current is measured by current meter 124. Polarizing working electrode 56 relative to reference electrode 58 at the indicated potential provides sensitivity towards oxidants such as oxygen, chlorine and ozone. For example, at 0.00 V polarization between working electrode 56 and reference electrode 58 the current drawn represents the sum of oxygen, chlorine and ozone. At 0.35V polarization between working electrode 56 and reference electrode 58 the current drawn represents the sum of chlorine and ozone. At about 0.70V polarization between working electrode 56 and reference electrode 58 the current drawn represents only ozone concentration. In a refinement, voltage meter 122 and current meter 124 are module digital components that provide their output to processor 128 in FIG. 1.

Ozone sensor assembly 18 is operated in potentiometric mode by the two electrode operation illustrated in FIG. 9B. In this variation, voltage meter 130 measures the potential difference between reference electrode 58 and counter electrode 60. The potentiometric mode provides oxidation reduction potential (ORP) of a media. In combination the potentiostatic measures and the potentiometric measure provides information about safety of water for domestic use. For media such as tap water, characterization one would choose a sequence of measurements i.e. ORP followed by residual oxidant at 0V, 0.35V and 0.7V. The potentiostatic measures giving information about the amount and identity of oxidant present in media. Based on this, a theoretical ORP can be calculated and compared to the actual ORP giving away presence of un-oxidized organics (chemicals or biologic materials) in the water either if actual ORP is low, less than 200 mV vs SHE, or if ORP_{calc} minus ORP_{act} difference is larger than 300 mV. In a refinement, voltage meter 130 is a module digital component that provides their output to processor 128 in FIG. 1.

The theoretical basis for the potentiostatic operation is as follows. By applying an electric potential, E_{WE-RE}, to working electrode 56 relative to reference electrode 58, the resulting current from the working electrode 56 to counter electrode 60, I_{WE-CE}, is a measure of the oxidants concentration, C, available at electrode surface for reduction. This current is negative if oxidants are dominating the solution and vice versa positive if reductants dominate. The surface concentration changes as a result of the reduction and a concentration gradient develops,

$$- \frac{\partial C}{\partial x} .$$

Equation (1) can be used to determine the current

$$I = {nFAD ( \frac{\partial C}{\partial x} )}_{0} \qquad ( 1 )$$

where I is a current, A is the area of the working electrode, C is the concentration at the electrode working surface (i.e., x=0), n is the stoichiometric constant for the reduction process, F is the Faradays constant, and D is the diffusion coefficient for the oxidant in water. The solution to equation (1) in time, for plane geometry yields the Cottrell equation (2):

$${I}_{d} ( t ) = \frac{{nFAD}^{1 / 2} {c}_{∞}}{{( π t )}^{1 / 2}} \qquad ( 2 )$$

Where I_{d}(t) is the time dependent diffusion limited current, t is time, and C_{∞} is the bulk concentration. The oxidant solution concentration can now be express via the following linear equation 3:

[Ox]=al+b (3)

where [Ox] is the oxidant concentration, I is the current at a given potential, a is the gain, and b is a zero adjustment

Equation (2) stated that the current is diffusion limited. It is therefore essential to find conditions that put a lid on variations and magnitude of diffusion limitations for Equation (3) to have merit. Fluid velocity is key. High sensitivity occurs when thin diffusion layer thickness can be established, i.e. at high flow velocities. Stable sensitivity occurs when constant diffusion layer thickness can be established, i.e. at high flow velocities. Short response time is limited by capacitive and nonlinear diffusion effects. Diffusion settles faster in a steady state situation when diffusion layer is thin, i.e. at high flow velocities.

The area and/or activity of the working electrode 56 is a concern. The working electrode 56 (e.g. platinum, gold) may be covered with an oxide or other layers precipitating during the course of operation in effect altering reactivity and sensitivity of electrode to oxidants. A practical approach to establishing reproducible working electrode performance is to engage the electrode in periodic polarity reversals for cleaning and reestablishing a nascent/original state of electrode surface. This option is not available if the electrode materials are gold as gold tends to dissolve anodically in the presence of chloride.

If flow is not constant but known, the gain factor “a” changes to a flow velocity corrected constant

$$“ ( \frac{{V}_{ref}}{{V}_{i}} ) a ” ; \\ [ Ox ] = ( \frac{{V}_{ref}}{{V}_{i}} ) aI + b \qquad ( 4 )$$

where V_{ref} is the reference fluid and V is the actual fluid velocity. The ORP is taken from the potential difference between the work electrode and the reference at zero current.

E_{WE}−E_{RE}=E_{ORP}. (5)

The ORP in turn is a weighted average of all the redox pairs in the solution each contributing a potential according to the Nernst equation:

$$E = {E}^{0} + \frac{RT}{zF} ln \frac{[ Ox ]}{[ Red ]}$$

Minute concentrations of oxidants have profound effect on ORP due to the log sensitivity of the expression. ORP is therefore a good measure for low concentrations (potentiometric measure) while higher concentrations are better quantified via the residual oxidant expression (potentiostatic measures).

The following examples illustrate the various embodiments of the present invention. Those skilled in the art will recognize many variations that are within the spirit of the present invention and scope of the claims.

Screen Printed electrodes, SPE, RR1002PT and RR1002Au, were purchased from Pine Research, www.pineresearch.com and was used as ozone sensors. These screen-printed electrodes include a small working electrode, a small Ag|AgCl reference electrode both surrounded by a counter electrode. In another configuration the reference electrode is substituted by a reference electrode auxiliary (i.e., separate reference electrode assembly).

Data collection was done using 8 channel potentiostat, VMP-Perkin Elmer/Biologic. Six independent data traces were collected: ozone generator voltage and current. Reference values for ORP (Mettler Toledo) and ozone concentration (ATI) along with Iox (@-0.35V vs Ag|AgCl internal) and Iox (@-0.35V vs Ag|AgCl auxiliary) using two separate RR1002PT electrodes were provided. Ozone generator was monitored using a voltage drop over small resistor current and voltage divider for potential. Data collection on all six channels were done on 10-50 Hz basis over a time span of 10-20 minutes. Ozone generator and water was manually turned on and off during this time. Color metric ozone method, AccuVac/HACH, DR900/HACH spectrometer was used as an independent check of ozone concentration.

Results and discussion.

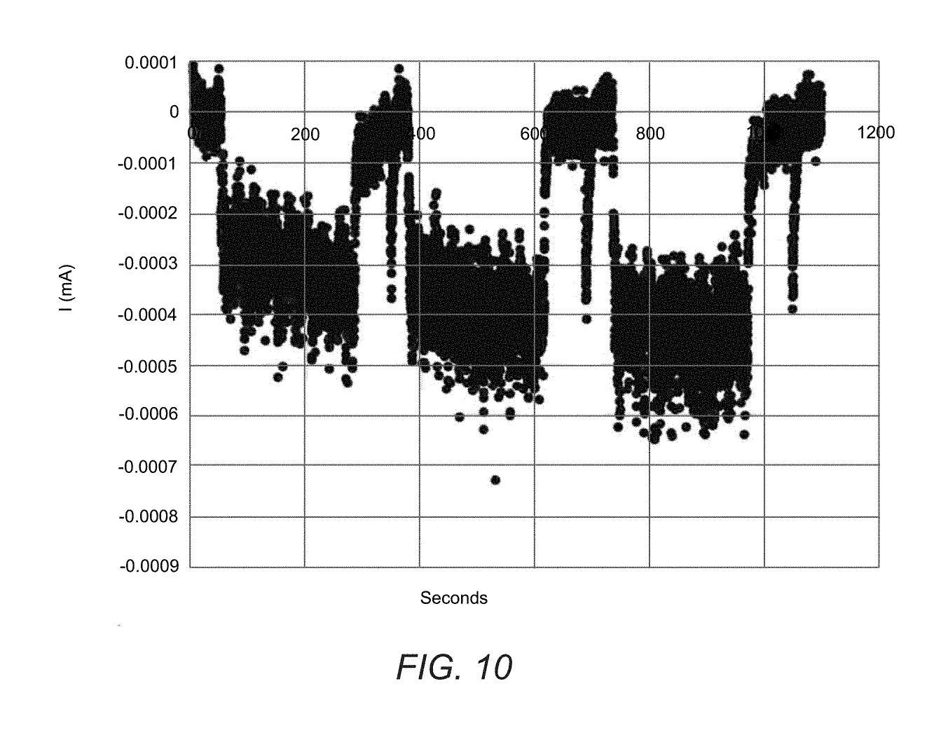

The chip ozone sensor (i.e., ozone sensor assembly 18 described above) relies on the concept that any oxidant exposed to a cathodic polarized platinum electrode is reduced, in the case of ozone the reduction product is water, producing a current proportional to the concentration of the oxidant. The input to the sensor is a driving potential relative to a reference, in our case −0.35V vs Ag|AgCl reference which turns out to be 0V vs SHE on absolute scale. The potential was adopted because it produced no sensitivity to oxygen in preliminary studies. The output from the sensor is a current that because of choice of polarization potential is linear with ozone and zero current for zero ozone. The currents measured during experiment are shown in FIG. 10.

The observed currents are between 0-600 μA, negative in value due to sign convention for reduction processes. There is obviously quite some noise in our system. The noise comes in two flavors; 60 Hz line noise and a 0.05 Hz polarity inversion shift noise—both can be successfully removed in an application. The currents are presented as ozone concentration via the algorithm:

[O₃](ppm)=[Ox]=a(I)+b

assuming the ozone concentration is the only oxidant and a=−2400, b=0.

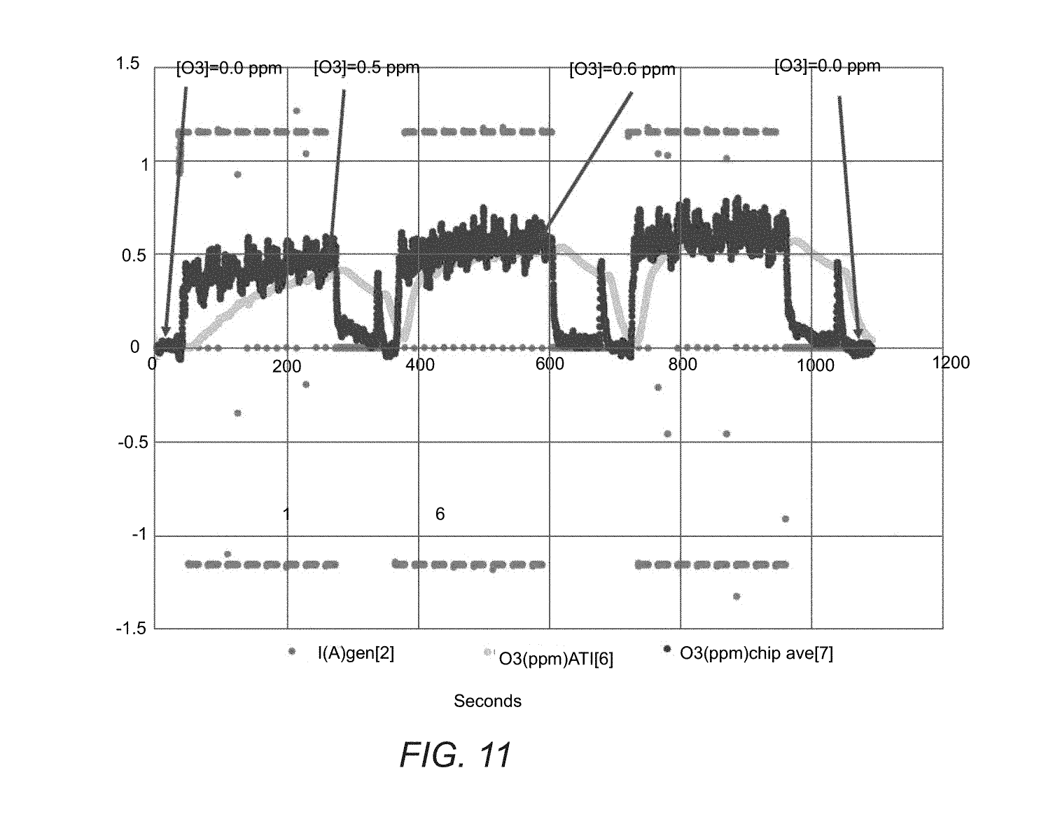

A dataset showing that the ozone generator was turned on after 35 seconds (˜20V) and periodically turned off and on was collected. On-off cycles were done several times and finally generator turned off at 960 seconds. It is easier to follow trends when the restricting scale and traces were displayed (FIG. 11). The ozone generator was interrupted 3 times. The ozone trace from ATI sensor [6] is lagging and in somewhat disagreement with chip average [7] and color metric measurements (inserted in top of chart). Two seconds average is used for display. Extending average to 5-10 seconds will eliminate noise but kill response time. It is somewhat visible that the generator polarity, reversing on 20 second basis, is biasing the chip reading.

At this point it is unclear why the ATI sensor shows lagging ozone measurements and why ozone levels increase as the experiment progresses under identical generator conditions. The ATI is operated in a side branch of the flow and one could speculate that inner surfaces of the measurement trough initially consumes ozone both producing a delayed and muted response. After 500 seconds, the ATI and chip readings are in agreement albeit with a significant delay of ATI. It is certainly possible that the ozone generator is producing chlorine from chloride in the feed water in 0.2 ppm range—in part explaining poor fit between chip and ATI for low non-zero ozone concentrations.

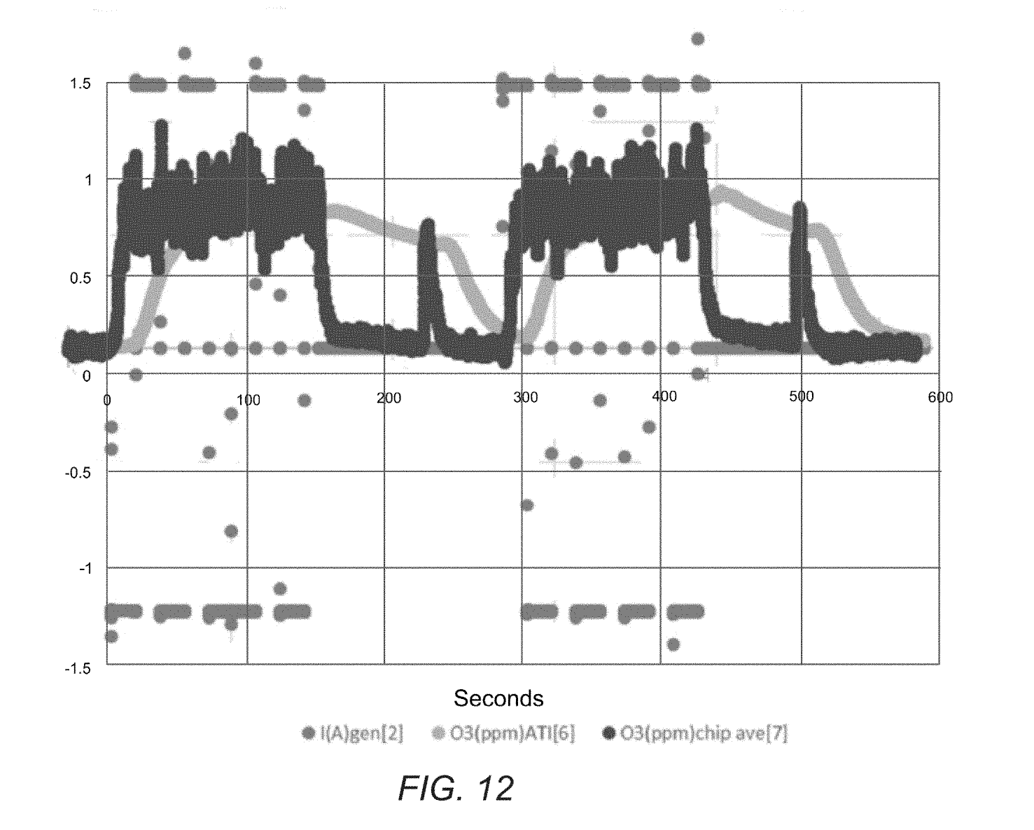

The time response is analyzed as follows. In a second execution of the experiment, the sampling rate was increased to 50 Hz but essentially executed the same way (FIG. 12). There are three principal focus areas in this experiment: generator on—around 30 seconds and 270 seconds; generator off water flow stopped—around 150 seconds and 400 seconds; and generator off water flow started—around 225 seconds and 450 seconds.

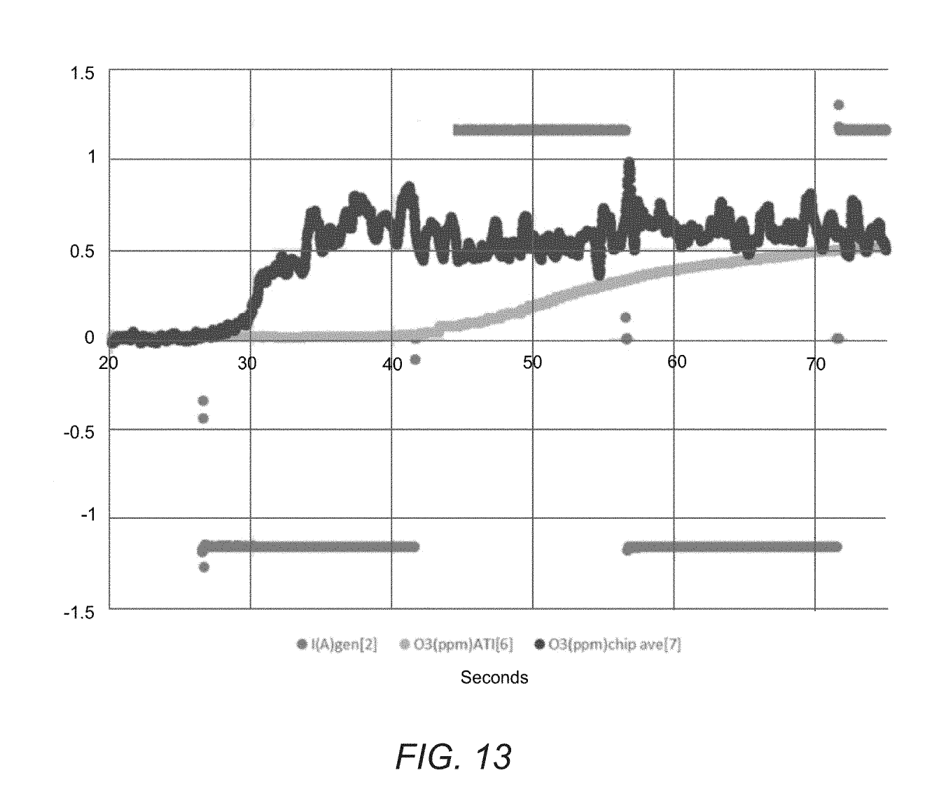

A Generator on event is shown in FIG. 13. In this experiment, the three principal focus areas are: generator on—around 30 seconds and 270 seconds; generator off water flow stopped—around 150 seconds and 400 seconds; and generator off water flow started—around 225 seconds and 450 seconds

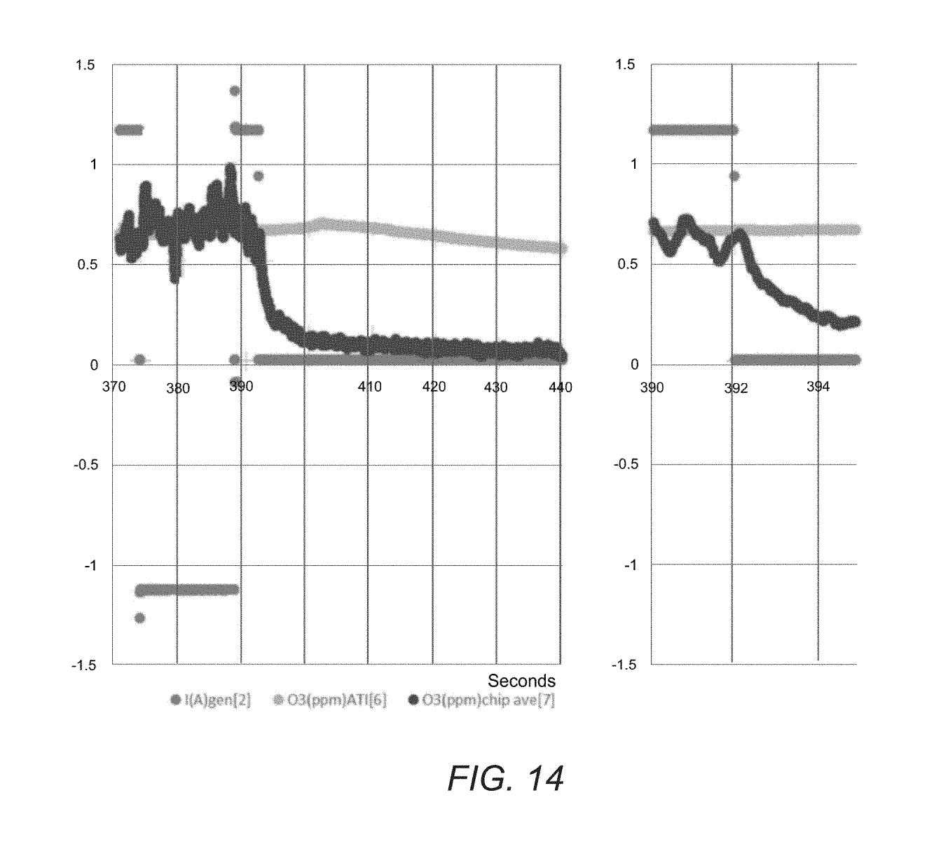

A Generator off event is shown in FIG. 14. From graph, it is observed that the response to turning the ozone generator off is happening within 0.5 seconds for the chip while the ATI sensor is slow with a falling trend after +10 seconds. In any event, the fast response of the chip sensor is interesting and warrants more scrutiny.

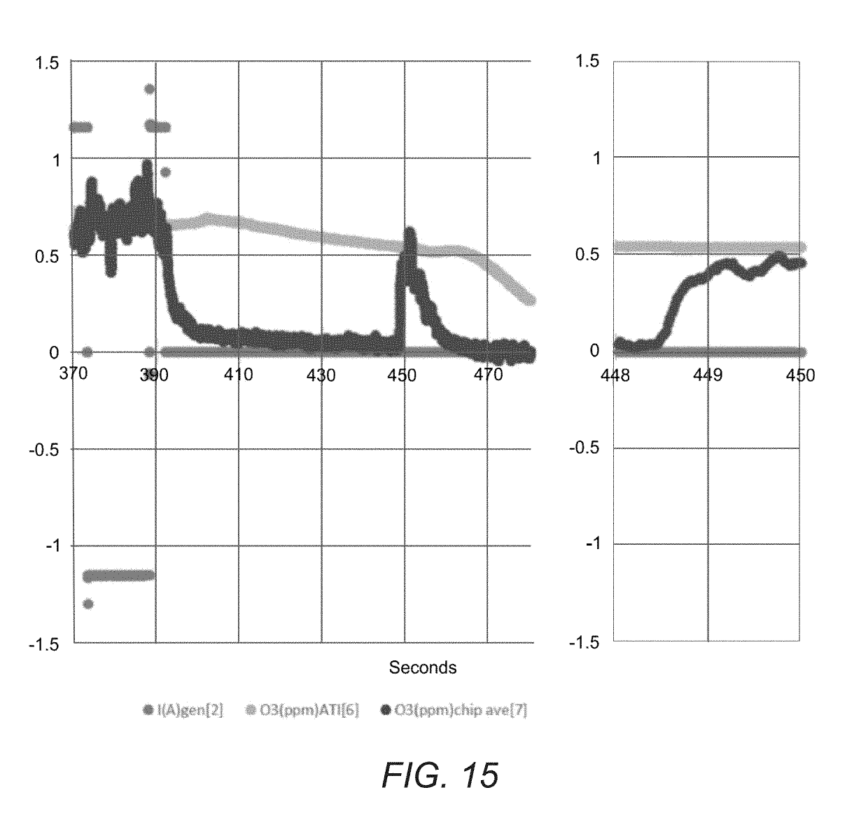

The generator turnoff procedure can be done while water continues to flow or is shut off. If the water is shut off for a time followed by a period when water is flowing while the generator is off the following generator off water flow started picture comes up (FIG. 15). At 392 seconds the generator and flow is turned off. A minute later, at 448.5 seconds, the water is turned on. The chip trace [7] shows the following features: immediately after the turn off the sensed ozone concentration drops from 0.6 ppm to 0.2 ppm; continuing drop over a minute to 0.1 ppm. (FIGS. 14, 15) and upon turning the water on the sensed ozone increases to 0.5 ppm level and then drops off to zero level. FIG. 15. These results imply that the sensor signal relies on availability of ozone at the electrode surface. With no flow, the sensor consumes ozone depleting the diffusion layer covering the electrode making the signal diffusion limited—while ozone concentration in bulk is essentially unchanged. Turning the water on creates a convection limited situation—water covering the electrode is replenished with bulk water containing ozone and the current consumption goes up attaining signal reflecting bulk ozone concentration.

Ozone concentration remains essentially unchanged in the bulk during the one minute water turn off period and so the response time of the sensor is a measure of how fast the diffusion layer in front of the electrode can be replenished by bulk independently of other time delays created by ozone generator starting up and capacitive effects in the water path. The response time is therefore a function of the diffusion layer thickness, in turn, a function of bulk flow velocity parallel to the electrode surface. Which is to say; faster flow velocity equates to faster response time.

The true response time of the chip can therefore be found when the ozone containing water is turned on after a period of no flow. The response time was found to be within 0.5 seconds (+80% response) and can be improved with increased fluid velocity, turbulent flow.

### CONCLUSIONS

A commercially available electrode setup with two Pt electrodes and a silver reference electrode was tested for feasibility as fast responding ozone sensor for feedback control of ozone generator. Our findings show that the sensor produces signals in range 1000 μA/ppm ozone and a linear response to oxidant concentration, has minimal if any sensitivity to oxygen, has probable sensitivity to chlorine in feedwater or, as produced by generator, has response time of 0.5 seconds in current configuration, and has noise in 100 μA/60 Hz range and prone to bias from polarization of ozone generator

The study has revealed fundamentals of dynamics enabling improved response time and reduced noise. It is recommended to continue development of sensor aiming at prototyping hardware for sensor operation, noise reduction and feedback operation of ozone generator. This work should be done in parallel with work done by Pronghorn.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An ozone sensor comprising:
a hollow housing having an inlet and an outlet, the hollow housing defining a cavity that is adapted to receive water from the inlet and discharge water through the outlet, the cavity being defined by a bottom wall, a top wall and sidewall; and
an electrode including a working electrode, a counter electrode, and a reference electrode, the electrode assembly positioned in the cavity such that the reference electrode is below the inlet and outlet when ozone is incorporated in a water line such that the hollow housing retains water.

2. The ozone sensor of claim 1 wherein the cavity is defined by a bottom wall, a top wall and sidewall.

3. The ozone sensor of claim 1 wherein the reference electrode is positioned at a distance below the inlet and outlet that is smaller than the distance of the bottom wall from the inlet and the distance of the bottom wall from the outlet.

4. The ozone sensor of claim 1 wherein the hollow housing has a hollow columnar side to which the inlet and the outlet are attached, the hollow columnar side wall having a first edge and a second edge, the inlet positioned at a first distance from the first edge and the outlet positioned at a second distance from the first edge;
a bottom wall attached to the first edge;
a top flange removably attached to the second edge, the hollow columnar side wall, the bottom wall, and the top flange defining a chamber that can receive water through the inlet and discharge water through the outlet; and
an electrode assembly that includes a working electrode, a counter electrode, and a reference electrode, the electrode assembly being attached to the top flange such that the reference electrode is positioned at a third distance that is less than the first distance and the second distance.

5. The ozone sensor of claim 4 wherein the inlet and outlet are substantially across each other on the hollow columnar side wall.

6. The ozone sensor of claim 1 wherein the reference electrode is a silver chloride electrode (Ag/AgCl).

7. The ozone sensor of claim 1 wherein the working electrode and the counter electrode each independently include a precious metal.

8. The ozone sensor of claim 1 wherein the working electrode and the counter electrode each independently include platinum or gold.

9. The ozone sensor of claim 1 further comprising a switching assembly that selects between a three electrode arrangement using the working electrode, counter electrode, and the reference electrode in a measurement and a two electrode arrangement using the working electrode and the reference electrode.

10. The ozone sensor of claim 9 wherein the three electrode arrangement allows potentiostatic measurements of residual oxidant using levels of potential to gage oxidant potency

11. The ozone sensor of claim 1 wherein the working electrode is a gold electrode, the counter electrode is a platinum electrode, and the reference electrode is a silver chloride electrode.

12. The ozone sensor of claim 1 wherein the working electrode and the counter electrode are each independently patterned coatings disposed on a substrate.

13. The ozone sensor of claim 9 wherein orientation of the electrode assembly is adjustable with respect to flow.

14. The ozone sensor of claim 13 wherein the substrate is fixed to the top flange, the top flange being rotatable with respect to the hollow columnar side wall to change orientation of the planar portion.

15. The ozone sensor of claim 1 wherein the potential between the working electrode and the reference electrode is selected from a value of about 0V, about 0.35, or about 0.70V.

16. The ozone sensor of claim 1 further comprising a wiper for periodically cleaning electrode surfaces for debris, lime scale and biofilm build-up.

17. The ozone sensor of claim 1 further comprising flexible electrode flap design ensuring a minimum fluid velocity given a minimum flow enabling stable gain for residual oxidant measure irrespective of non-zero flow.

18. The ozone sensor of claim 1 wherein orientation of the electrode assembly with respect to the inlet is adjustable such that water velocity over a surface of the electrode assembly can be varied.

19. A system for treating water with ozone:
an ozone generator disposed in a water supply line; and
an ozone sensor disposed in a water supply line upstream of the ozone sensor, the ozone sensor comprising:
a hollow housing having an inlet and an outlet, the hollow housing defining a cavity that is adapted to receive water from the inlet and discharge water through the outlet, the cavity being defined by a bottom wall, a top wall and sidewall; and
an electrode including a working electrode, a counter electrode, and a reference electrode, the electrode assembly positioned in the cavity such that the reference electrode is below the inlet and outlet when ozone is incorporated in a water line such that the hollow housing retains water;
a controller in electrical communication with the ozone generator and the ozone sensor, the controller adjusting the amount of ozone generated by the ozone generator by feedback from the ozone concentration determined by the ozone sensor.

20. The system of claim 19 wherein the cavity is defined by a bottom wall, a top wall and sidewall.

21. The system of claim 19 wherein the reference electrode is positioned at a distance below the inlet and outlet that is smaller than the distance of the bottom wall from the inlet and the distance of the bottom wall from the outlet.

22. The system of claim 19 wherein the hollow housing has a hollow columnar side to which the inlet and the outlet are attached, the hollow columnar side wall having a first edge and a second edge, the inlet positioned at a first distance from the first edge and the outlet positioned at a second distance from the first edge;
a bottom wall attached to the first edge;
a top flange removably attached to the second edge, the hollow columnar side wall, the bottom wall, and the top flange defining a chamber that can receive water through the inlet and discharge water through the outlet; and
an electrode assembly that includes a working electrode, a counter electrode, and a reference electrode, the electrode assembly being attached to the top flange such that the reference electrode is positioned at a third distance that is less than the first distance and the second distance.

23. The system of claim 19 wherein the controller receives feedback from the ozone sensor to control the ozone sensor such that dissolved ozone is set within a predetermined range.

24. The system of claim 19 wherein the controller receives feedback from the ozone sensor to control the ozone sensor such that dissolved ozone is set within a predetermined range.

25. The system of claim 19 further comprising a switching assembly in communication with the control and the electrode assembly, the switching assembly selecting between a three electrode arrangement using the working electrode, counter electrode, and the reference electrode in a measurement and a two electrode arrangement using the working electrode and the reference electrode.

26. The system of claim 25 wherein the three electrode arrangement is selected when ozone concentration is greater than a predefined ozone concentration and wherein the two electrode arrangement is selected when the ozone concentration is below the predefined ozone concentration.
